(19) United States
(12) Patent Application Publication
(10) Pub. No.: US 2022/0234833 A1
(43) Pub. Date: Jul. 28, 2022

(54) MODULAR ACCESSORY FOR PANEL ADHERENCE DEVICES

(71) Applicant: Eric William Rolseth, Dayton, MN (US)

(72) Inventor: Eric William Rolseth, Dayton, MN (US)

(21) Appl. No.: 17/585,523

(22) Filed: Jan. 26, 2022

Related U.S. Application Data
(60) Provisional application No. 63/142,484, filed on Jan. 27, 2021.

(51) Int. Cl. B65G 17/12; B32B 38/18

(52) U.S. Cl. CPC B65G 17/12; B65G 2201/022; B32B 38/18

(57) ABSTRACT

A modular accessory for panel adherence devices that rigidly supports a panel during handling operations, which includes one or more bridge or span rails each being positioned alongside and connecting to the panel adherence device and respectively having recessed portions or outward arms for engaging one or more box rails. The modular accessory further includes peripheral devices in the form of an end rail and a spacing bar for connecting together multiple box rails, a bridge rail clamp for unifying connectivity between the bridge rail and box rail, a box rail lock for advancing connectivity between the box rail and panel, a corner support for establishing a pre-set orientation and connection of a pair of box rails, and one or more moveable handles individually attached to an end of the box rail to supplement handles integrally associated with the structure of the bridge or span rail as well as with those possibly existing with the panel adherence device.

### CROSS-REFERENCE TO RELATED APPLICATIONS

This application claims the benefit of U.S. Provisional Application No. 63/142,484, filed Jan. 27, 2021, entitled “Modular Accessory for Panel Adherence Devices,” the disclosures of which, including all attached documents, are incorporated herein by reference in their entirety for all purposes.

### FIELD OF THE INVENTION

The present invention is generally directed to a modular accessory for panel adherence devices of the type that operably attach to individual panel products or sheet goods for fulfilling handling and transfer operations. More particularly, the modular accessory readily attaches to and conjunctively operates alongside the panel adherence device and engages the planar surface of the panel to assistively carry and maneuver moderately-sized, heavily-weighted panels regardless of orientation, while mitigating occurrences of material bending and twisting that may possibly exceed the flexural strength of the panel and result in stress fractures and irreversible damage to the panel.

### BACKGROUND OF THE INVENTION

Panel products or sheet goods of the type typically used for the construction industry, for example, may vary significantly in dimension and comprise a material composition ranging from foam to stone respectively constituting a panel's weight as light to heavy. During aspects of the manufacturing process, panels are mainly conveyed along an infrastructure of conveyer belts and/or roller platforms, whereupon completing fabrication, the panels may be individually stacked for transport or shipment on pallets, carts or containers using articulating arms configured with an arrangement of vacuum lifting plates that suitably engage with the planar surface of the panel to fulfill lifting and stacking tasks. Although transfer management of the panels during manufacture presents little to no challenge given the adequacy of the process' design, it becomes increasingly more difficult to manage handling and maneuverability of the panel at moments of intermediate transfers after manufacture and installation, particularly if the panel is of sizeable dimension and heavily-weighted. Under most case scenarios, however, the panel is commonly and typically managed by personnel hand carrying the panel a short distance to yield its interim or final placement.

In recognition of the issues, a number of devices have been developed over time to fulfill ease by which one can lift, handle, transport, carry, and maneuver the individual panel for specific end uses and installations, while minimizing opportune moments of damage to the panel. In a simple, yet effective approach, a panel carrier of the type comprising an extended arm fitted at one end with an integrated handle and an opposite end configured with a hook-shaped portion that possesses capability to engage with a longitudinal side of the panel enables one or more individuals to load, lift and carry the panel substantially vertically to its intended destination Similar in concept, a panel dolly effects transfer of panels in like manner, whereby a framed receptable accepts and holds the longitudinal side of the panel while wheels attached to the framed receptable further aspects of movability without necessity of carrying the ensemble, with exception of initially loading the panel onto the panel dolly. Despite their simplicity, there remains issues associated with stability and bending of the panel to an extremity of possible breakage, as well as the inability to lift the panel vertically from its planar surface for placement upon a horizontal surface, for example.

In resolving the issue, where lifting of the panel from its planar surface is made possible, the art has devised portable panel adherence devices that in form may comprise a body and handle assembly configured with one or more suction cups capable being pressed onto the planar surface for ultimate hold thereon and a portable, hand-held vacuum plate lifter, generally resembling those used in the manufacturing process of panels. Vacuum plate lifters in general include a unified body configured with a bottom perimeter seal with aspects of deformability to form an underside vacuum chamber and operate on the principle of pneumatics, whereby a negative pressure is created and maintained within the vacuum chamber by a hose connecting to a vacuum pump source or alternatively by a compressed air source incorporating use of an adapter that fulfills a venturi effect. Regardless of the negative pressure source, one or more vacuum plate lifters can be placed anywhere relatively about the planar surface of the panel so as to facilitate lifting and carrying of the panel, regardless of the orientation of panel, but with due concern of weight limitations, as slippage may occur with heavier panels. The vacuum plate lifter may include provisions for direct handling thereof while attached to the panel, such as a bar handle attached to and extending from the body. In a more elaborate configuration, the capabilities to generate negative pressure may be embodied and integrated within the construct of the vacuum plate lifter that furthers unhindered management and placement of multiple vacuum plate lifters without due concern of and interference from piping or air supply lines extending from the vacuum pump or air compressor, such as the model manufactured by Nemo Power Tools Limited of Hong Kong, China and sold under the registered trademark Grabo®.

Although portable panel adherence devices in general are effective for their intended purpose of readily attaching to the planar surface of the panel and offering capabilities of handling and transporting the panel to its destination, there remains unresolved issues of unwanted bending, flexing, and twisting of the panel that may possibly exceed the flexural strength of the panel and cause breakage. Accordingly, there remains a need for a modular accessory that readily connects to and conjunctively operates with a variety of portable panel adherence devices, particularly offering to establish unified support for increased overall rigidity of the panel while it is being lifted from its planar surface for placement upon horizontal surfaces, such as for stacking and installation purposes.

### BRIEF SUMMARY OF THE INVENTION

In order to overcome the numerous drawbacks apparent in the prior art, a modular accessory for panel adherence devices has been devised for readily attaching to and conjunctively operating with panel adherence devices, such as vacuum plate lifters and suction cup plates of the particular type capable of adhering to the planar surface of the panel.

It is an object of the present invention to provide a modular accessory for panel adherence devices that is modular and forms a structural framework to maintain overall rigidity of a panel such to lessen inadvertent opportunities of bending, flexing and twisting that may possibly exceed the flexural strength of the panel's material composition.

It is a further object of the present invention to provide a modular accessory for panel adherence devices that includes integrated handles so as to sufficiently establish multiple handling locations relatively about the panel for secure and safe transport thereof, irrespective of its orientation.

It is yet another object of the present invention to provide a modular accessory for panel adherence devices is relatively simple in terms of design and construction and can be readily assembled for use alongside the panel adherence device.

It is yet another object of the present invention to provide a modular accessory for panel adherence devices that consists of modular, functional components capable of being used independently, apart from an assembly that offers to maintain rigidity of the panel.

It is a further object of the present invention to provide a modular accessory for panel adherence devices that can be used with and support panels of varying dimension and material compositions, including, for example, thin, fragile sheets of porcelain and ceramic, as well as thick, heavy panels of granite and marble.

In accordance with the present invention a modular accessory for panel adherence devices has been devised to advance support and rigidity to a panel to enable safe handling and transport thereof to a desirable location, the modular accessory substantially including one or more bridge rails each being positioned alongside and connecting to the panel adherence device and having recessed portions for engaging top planar surfaces of box rails, the modular accessory further including peripheral devices in the form of an end rail and a spacing bar for connecting together multiple box rails, a bridge rail clamp for unifying connectivity between the bridge rail and box rail, a box rail lock for advancing connectivity between the box rail and panel, a corner support to further a perpendicular orientation and connection of a pair of box rails, and one or more moveable handles each being capable of attachment to an end of the box rail to supplement the existence of handles integrated within the structure of the bridge rail as well as generally associated with the panel adherence device, whereby activation of the adhering functionality of the panel adherence device in association with the panel consequentially interacts with the unified structure offered by the modular accessory to advance overall support and rigidity to the panel that minimizes the effects of bending and twisting thereof during handling operations, regardless of its orientation.

Other objects, features, and advantages of the present invention will become apparent in the following detailed description of the preferred embodiments thereof when read in conjunction with the accompanying drawings in which like reference numerals depict the same parts in the various views.

### BRIEF DESCRIPTION OF THE SEVERAL VIEWS OF THE DRAWINGS

A preferred embodiment of the present invention will now be described by way of example with reference to the accompanying drawings, in which:

FIG. 1 is a top perspective view of the preferred embodiment of the present invention illustrating box rails connecting to an end rail and bridge and span rails being positioned alongside and connecting to panel adherence devices to hold downwardly the box rails to a planar surface of a panel;

FIG. 2 is a top plan view of the preferred embodiment of the present invention illustrating a pair of bridge rails each configured with a panel adherence device in the form of a vacuum plate for holding in place a pair of box rails;

FIG. 3 is a cross sectional view of the preferred embodiment of the present invention taken along lines 3-3 in FIG. 2 illustrating a pair of bridge rails each configured with a panel adherence device having a deformable gasket forming an underside chamber;

FIG. 4 is a front perspective view of the preferred embodiment of the present invention illustrating a bridge rail of solid form and separable from a panel adherence device and a pair of box rails;

FIG. 5 is a front side perspective view of the preferred embodiment of the present invention illustrating a bridge rail having perimeter frame forming integral handles and an extended section configured with open sockets;

FIG. 6 is a top plan view of the preferred embodiment of the present invention illustrating a bridge rail;

FIG. 7 is a cross sectional view of the preferred embodiment of the present invention taken along lines 7-7 in FIG. 6 illustrating a bridge rail having an extended section configured with open sockets and a perimeter frame forming integral handles;

FIG. 8 is a front perspective view of the preferred embodiment of the present invention illustrating a first form of a span rail having an open framed member and a pair of outward arms;

FIG. 9 is a front elevational view of the preferred embodiment of the present invention illustrating a first form of a span rail having an open framed member formed by a pair of sides connecting to a top member and a pair of dual extending flanges;

FIG. 10 is a front perspective view of the preferred embodiment of the present invention illustrating a second form of a span rail having an open framed member and a pair of extended members residing above a pair of outward arms;

FIG. 11 is a front elevational view of the preferred embodiment of the present invention illustrating a second form of a span rail having an open framed member formed by a pair of sides connecting to a top member and a pair of extended members residing above a pair of outward arms;

FIG. 12 is a front perspective view of the preferred embodiment of the present invention illustrating a third form of a span rail having an open framed member, a pair of outward members, and an extended member residing above one of the outward arms and connecting to a vertical member forming an integral handle

FIG. 13 is a front elevational view of the preferred embodiment of the present invention illustrating a third form of a span rail having an open framed member formed by a pair of sides connecting to a top member, a pair of outward members, and an extended member residing above one of the outward arms and connecting to a vertical member forming an integral handle;

FIG. 14 is a front perspective view of the preferred embodiment of the present invention illustrating a fourth form of a span rail having an open framed member and an outward arm;

FIG. 15 is a front elevational view of the preferred embodiment of the present invention illustrating a fourth form of a span rail having an open framed member formed by a pair of sides connecting to a top member and an outward arm;

FIG. 16 is a front perspective view of the preferred embodiment of the present invention illustrating a fifth form of a span rail having an open framed member and an extended member residing above an outward arm;

FIG. 17 is a front elevational view of the preferred embodiment of the present invention illustrating a fifth form of a span rail having an open framed member formed by a pair of sides connecting to a top member and an extended member residing above an outward arm;

FIG. 18 is a front perspective view of the preferred embodiment of the present invention illustrating a sixth form of a span rail having an open framed member, an extended member residing above an outward arm, and a pair of extended side members connecting to a horizontal member forming an upper handle;

FIG. 19 is a front elevational view of the preferred embodiment of the present invention illustrating a sixth form of a span rail having an open framed member formed by a pair of sides connecting to a top member, an extended member residing above an outward arm, and a pair of extended side members connecting to a horizontal member forming an upper handle;

FIG. 20 is a side perspective view of the preferred embodiment of the present invention illustrating a bridge rail configured and attached to a panel adherence device for holding in place a pair of box rails and a bridge rail clamp attached to the box rail and having a hook mechanism engaging a lower support of the bridge rail;

FIG. 21 is a front perspective view of the preferred embodiment of the present invention illustrating a bridge rail of extended length and having a pair of extended sections each configured alongside and connected to a panel adherence device;

FIG. 22 is a top plan view of the preferred embodiment of the present invention illustrating a bridge rail of extended length and positioned alongside a pair of panel adherence devices;

FIG. 23 is a side perspective view of the preferred embodiment of the present invention illustrating a pair of bridge rails each positioned alongside and connected to a panel adherence device in the form of a vacuum plate for holding downwardly a pair of box rails;

FIG. 24 is a top plan view of the preferred embodiment of the present invention illustrating a bridge rail positioned alongside a panel adherence device and engaging a pair of box rails held in a spaced relation by a spacing bar attached thereto and a box rail lock simultaneously attaching to one of the box rails and a panel;

FIG. 25 is a side elevational view of the preferred embodiment of the present invention illustrating an end rail having adaptive blocks with each being configured with a slot and an aperture;

FIG. 26 is a top plan view of the preferred embodiment of the present invention illustrating an end rail having adaptive blocks with each being configured with a slot and an aperture suited for receiving an elongate pin;

FIG. 27 is a close-up plan view of the preferred embodiment of the present invention illustrating a spring-loaded pin for use with an adaptive block of an end rail;

FIG. 28 is a top plan view of the preferred embodiment of the present invention illustrating a spacing bar having a planar element at each of its ends and configured with a pair of bolts and square nuts;

FIG. 29 is a top perspective view of the preferred embodiment of the present invention illustrating a spacing bar having a planar element at each of its ends and configured with a pair of bolts and square nuts;

FIG. 30 is a front perspective view of the preferred embodiment of the present invention illustrating a corner support having two sides each configured with a profiled extension;

FIG. 31 is a side elevational view of the preferred embodiment of the present invention illustrating a corner support having two sides each configured with a profiled extension;

FIG. 32 is a front perspective view of the preferred embodiment of the present invention illustrating a corner support having two sides each configured with a bolt and square nut arrangement;

FIG. 33 is a side elevational view of the preferred embodiment of the present invention illustrating a corner support having two sides each configured with a bolt and square nut arrangement;

FIG. 34 is a front perspective view of the preferred embodiment of the present invention illustrating a bridge rail clamp having a rail adapter with first and second sideward members integrally connecting to a top plate, a connective member having a mount plate configured with a hook mechanism, and a cam lever attached to a mount post;

FIG. 35 is an exploded perspective view of the preferred embodiment of the present invention illustrating a bridge rail clamp having a rail adapter with first and second sideward members, a connective member having a mount plate configured with a hook mechanism, and a cam lever;

FIG. 36 is an exploded perspective view of the preferred embodiment of the present invention illustrating a box rail lock having a rail connector with first and second sideward elements, a cam ratching lever and a drop-down support;

FIG. 37 is a rear perspective view of the preferred embodiment of the present invention illustrating a box rail lock having a rail connector with a second sideward element connecting to a backing plate forming a space for accommodating a drop-down support;

FIG. 38 is a top plan view of the preferred embodiment of the present invention illustrating a box rail lock having a rail connector configured with a pair of cam mount blocks supporting connection of a cam ratching lever;

FIG. 39 is a top perspective view of the preferred embodiment of the present invention illustrating a moveable handle having an integral base connecting to an outward member and an adapter mount; and

FIG. 40 is a top plan of the preferred embodiment of the present invention illustrating a moveable handle having an integral base connecting to an outward member and an adapter mount configured with an aperture and an integral slot.

### DETAILED DESCRIPTION OF THE INVENTION

While this invention is susceptible of being embodied in many different forms, the preferred embodiment of the invention is illustrated in the accompanying drawings and described in detail hereinafter with the understanding that the present disclosure purposefully exemplifies the principles of the present invention and is not intended to unduly limit the invention to the embodiments illustrated and presented herein. The present invention has particular utility as a modular accessory that readily connects to and operates conjunctively with panel adherence devices of the type capable of attaching to a planar surface of a panel or a sheet of material to facilitate handling and transfer thereof to a desired location.

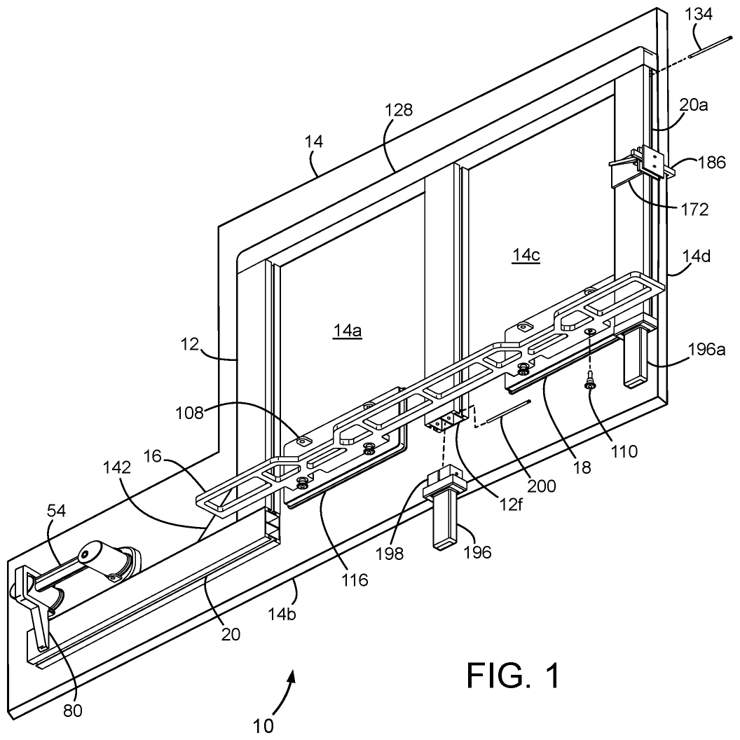

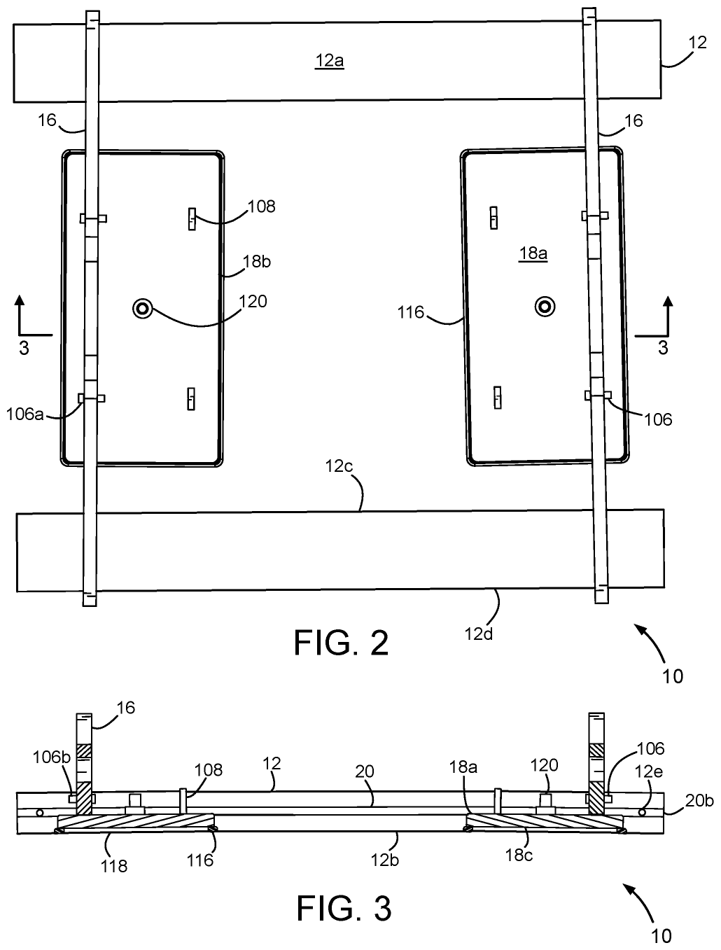

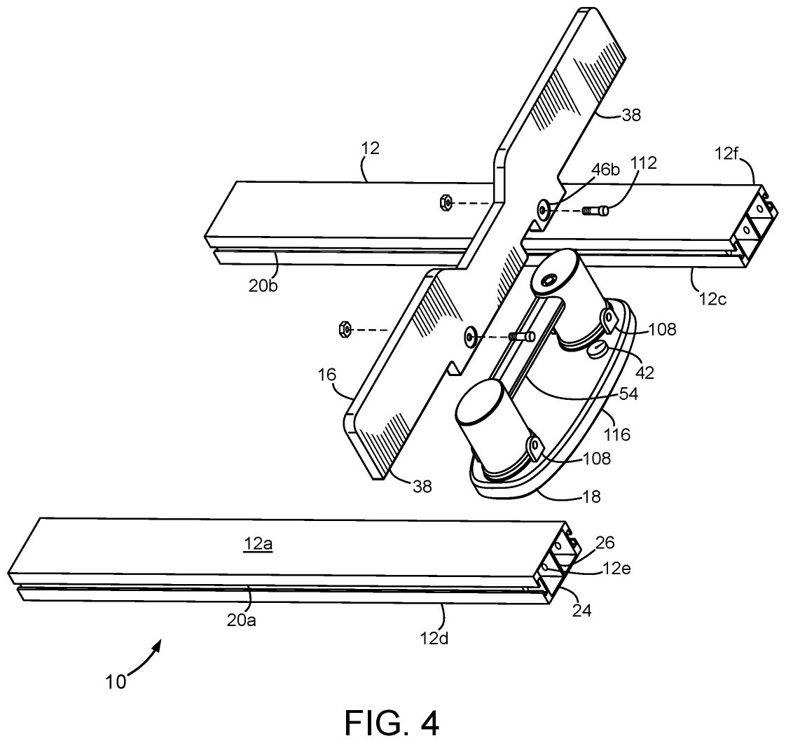

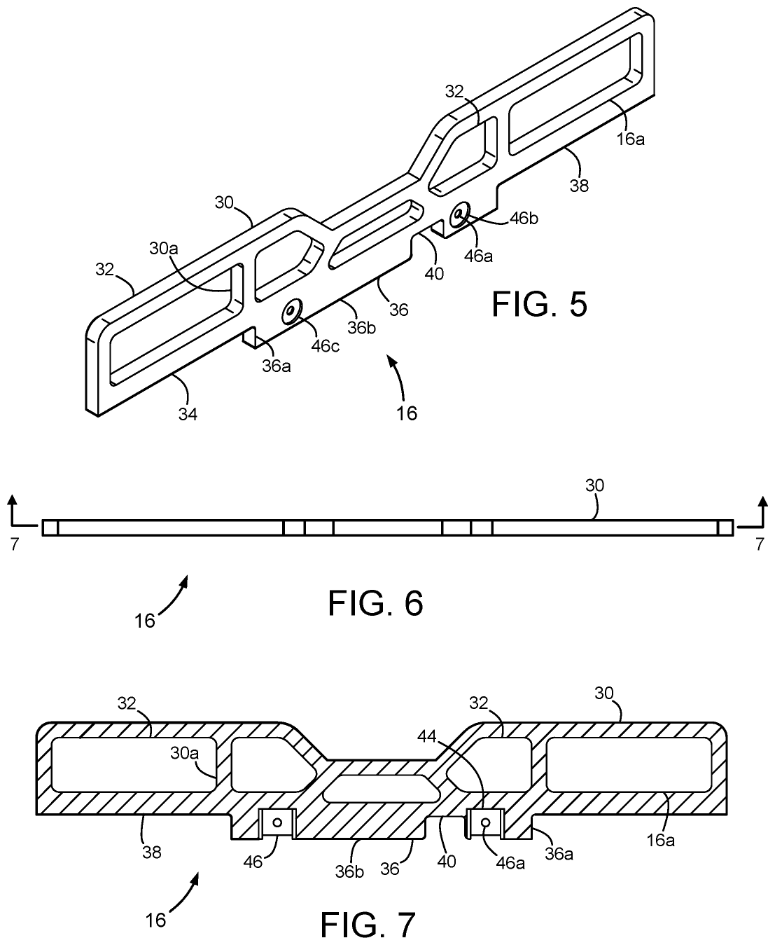

Referring now to FIG. 1, there is shown generally at 10 a modular accessory for panel adherence devices comprising a one or more box rails 12 suited for positioning relatively about a panel 14 and one or more bridge rails 16 that engage with the box rails and adaptively attaches to a panel adherence device 18 of the type commonly known in the art and capable of temporarily adhering to a planar surface 14a of the panel. The box rail in particular is shown in FIGS. 2 and 3 to comprise top and bottom planar surfaces 12a, 12b generally arranged in a parallel relation to one another and first and second longitudinal sidewalls 12c, 12d integral with and separable by the planar surfaces with each having a T-slot 20 integrally formed therein to connectively interact with one or more peripheral devices 22. Each individual box rail 12 may be solidly constructed or alternatively fabricated as an extrusion with a hollowed interior 24 and a center divider 26 forming a pair of longitudinal openings 28 extending the length of the box rail. Comparatively, each bridge rail 16, generally of rectangular configuration, is shown in FIG. 4 as comprising a solid, unified structure, or in the alternative, comprises a perimeter frame 30 with internal supports 30a forming integral handles 32 within the structure thereof, as in FIGS. 5-7. A bottom side 34 of the bridge rail is shown in FIGS. 5 and 7 to include one or more extended sections 36 extending downwardly therefrom to form recessed portions 38 at the ends of and, in some cases, intermediate about the length of the bridge rail that aptly accommodates and engages with the top planar surface 12a of the box rail, whereby the extended section comprises a pair of outward walls 36a each of dimensional length set by the difference in heights between the top planar surface 12a of the box rail and a top side 18a of the panel adherence device 18. The extended section may incorporate within its structure one or more cutouts 40 to spatially accommodate and bridge across operative components generally affiliated with the panel adherence device, such as a pressure gauge 42 of the type shown in FIG. 4. As illustrated in FIG. 7, each extended section is associated with one or more pairs of open sockets 44 extending upwardly from a bottom edge 36b of the extended section 36 and inwardly within the bridge rail 16 to operably interact with fastening means that assistively secures attachment of the bridge rail to the panel adherence device. Each open socket 44 is further shown in FIG. 7 to include a pair of support walls 46 with each being configured with an aperture 46a extending therethrough with one of the support walls having an exterior surface 46b configured with a cylindrical recess 46c to spatially accommodate structural aspects of fastening means while operating in a hold capacity.

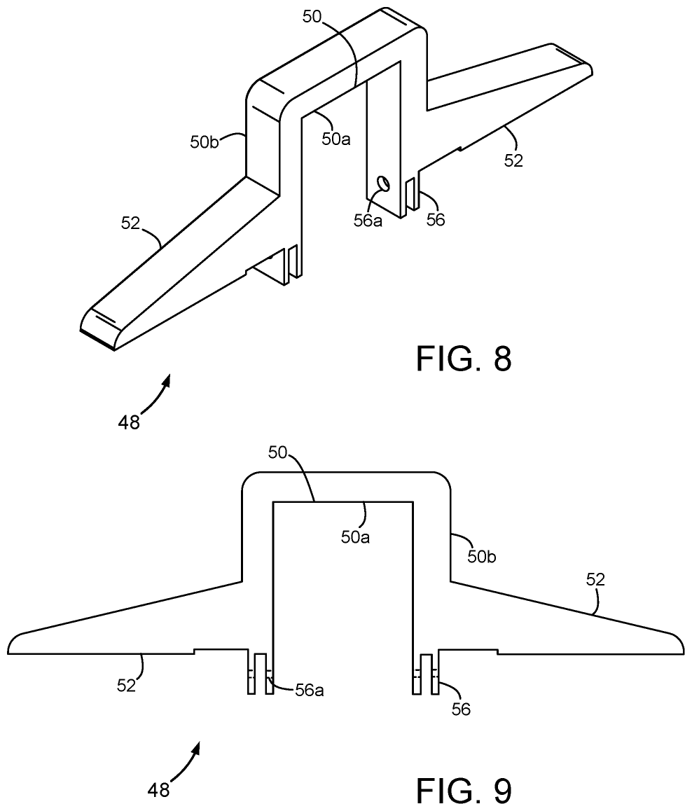

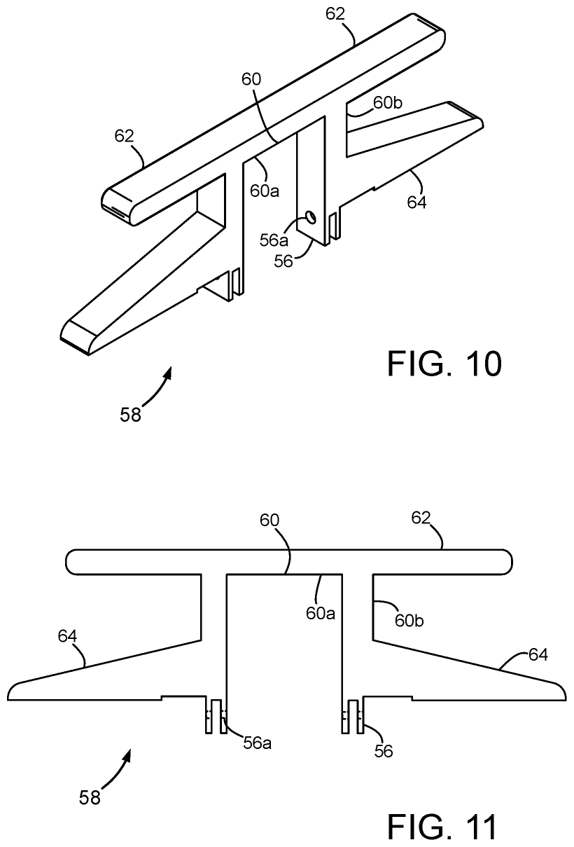

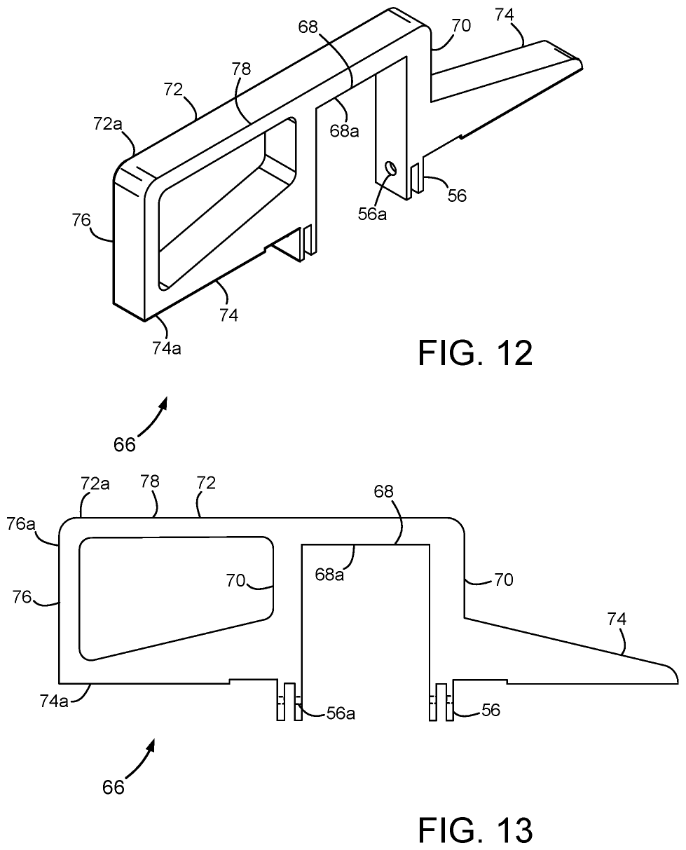

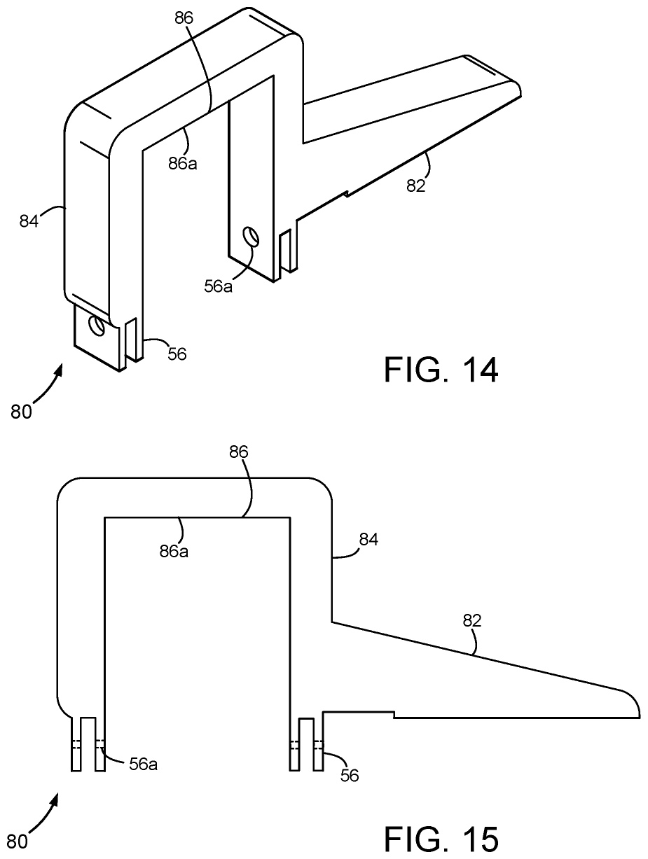

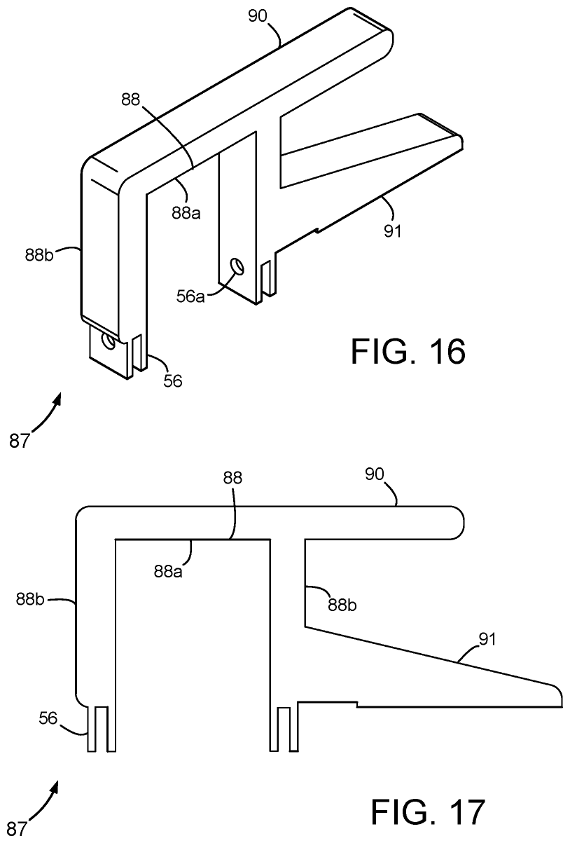

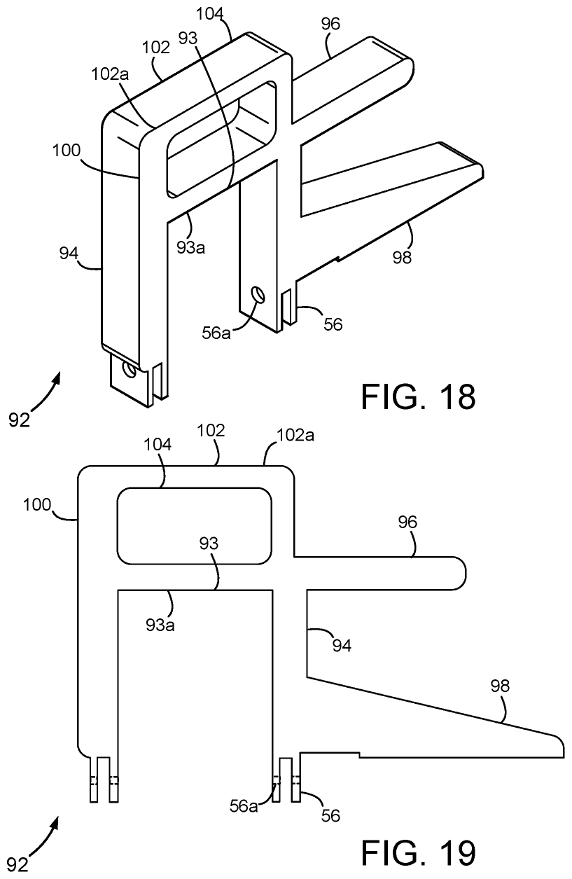

In accommodating confined and spatially restrictive areas relatively about the panel, the modular accessory 10 may incorporate within its assembly alternative, compact forms of the bridge rail that equivalently interact with and adapt to the box rails 12 and panel adherence device 18, such as typified in FIGS. 8-19. In FIGS. 8 and 9, a first form of a span rail 48 is shown therein as comprising an open framed member 50 formed by a top member 50a integrally connecting to a pair of sides 50b with each integrally connecting to outward arms 52 to fulfill engagement with the top planar surface 12a of the box rail to extend hold thereof, whereby the open frame member 50 is substantially suited to spatially accommodate physical features that may be inherently associated with select panel adherence devices, such as a handle 54 of the type shown in FIG. 4. Other structural features of the span rail include a pair of dual extending flanges 56 each appropriately configured with an aperture 56a to accommodate supplemental fastening means. To fulfill operability to the likes of the bridge rail, the dual extending flanges comprise a length equivalent to that of the outward walls 36a of the extended section 36 associated with the bridge rail. In a second form 58 of a span rail, substantially similar to the first form, a top member 60a of an open framed member 60 integrally extends outward beyond each side 60b of the open framed member to form a pair of extended members 62 that substantially resides relatively above a pair of outward arms 64, such as shown in FIGS. 10 and 11. In a third form of a span rail 66, as generally depicted in FIGS. 12 and 13, a top member 68a of an open framed member 68 integrally extends outward beyond one side of a pair of sides 70 to form an extended member 72 that substantially resides relatively above one of its outward arms 74, wherein a vertical member 76 connects at its ends 76a to a terminal end 72a of the extended member of the top member and an end 74a of the outward arm 74 to form an integral handle 78 within the structure of the span rail. Comparatively, as illustrated in FIGS. 14 and 15, a fourth form of a span rail 80, generally similar to the first form, limits its outward arm 82 to extend relatively outward from one side of a pair of sides 84 forming an open framed member 86 with that of a top member 86a. In a fifth form of a span rail 87, as shown in FIGS. 16 and 17, a top member 88a of an open framed member 88 integrally extends outwardly beyond one side of a pair of sides 88b to form an extended member 90 that substantially exists over one of its outward arms 91. In a final, sixth form of a span rail 92, a top member 93a of an open framed member 93 integrally extends outwardly beyond one side of a pair of sides 94 to form an extended member 96 that substantially exists over one of its outward arms 98, whereas each of the sides integrally extend beyond the position of the top member to form a pair of extended side members 100 that appropriately terminate to connect to ends 102a of a horizontal member 102 to form an upper handle 104 above the open framed member, such as generally represented in FIGS. 18 and 19.

Now in reference to FIGS. 1 and 2, fastening means and supplemental fastening means in each of their operative capacities respectively fulfills connection of the bridge rail 16 or various forms of the span rail to the panel adherence device, which in its simplest form, comprises a set pin 106 having a head portion 106a integrally connecting to a shaft 106b that possesses capabilities of being slidably positioned within the aligned arrangement of apertures 46c of the support walls 46 of the open socket 44, as in relation to the bridge rail, for example, and an aperture 108a integrated within the structure of an upright post 108 connecting to and extending upwardly from the top side 18a of a body plate 18b associated with the panel adherence device. In most applications, a pair of upright posts 108 positioned on each side of the panel adherence device adequately maintains the orientation and hold of the bridge rail 16 relatively in place alongside the panel adherence device while the recessed portion thereof engages and forcibly holds the box rail against the planar surface 14a of the panel. In the alternative case of making use of the span rail of any particular form thereof, as typified in FIG. 1, the pair of dual extending flanges 56 are configured to individually interact and engage with the upright posts associated from each side of or crosswise about the panel adherence device, particularly as such where the span rail would reside relatively perpendicular to select utilization of the bridge rail. Connectivity of the span rail to the panel adherence device is fulfilled by supplemental fastening means, generally operating to the likes of fastening means associated with the bridge rail.

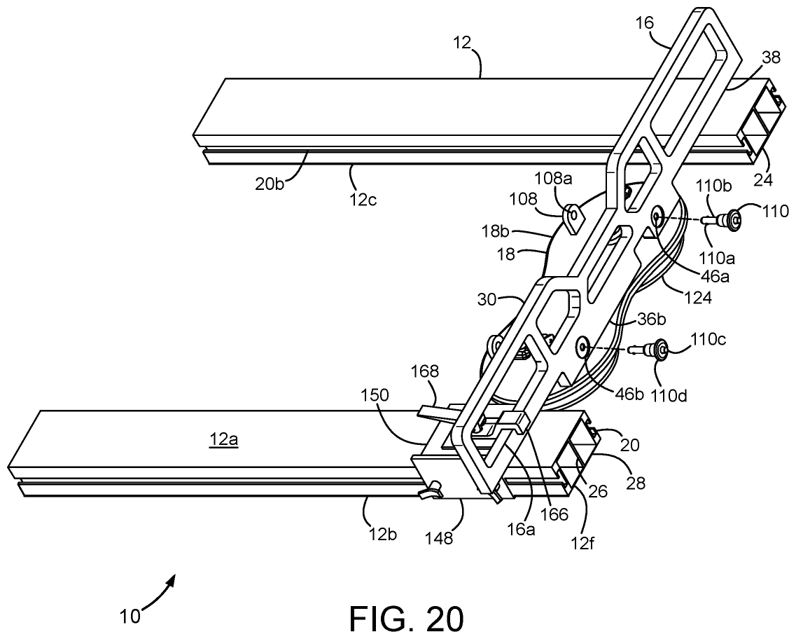

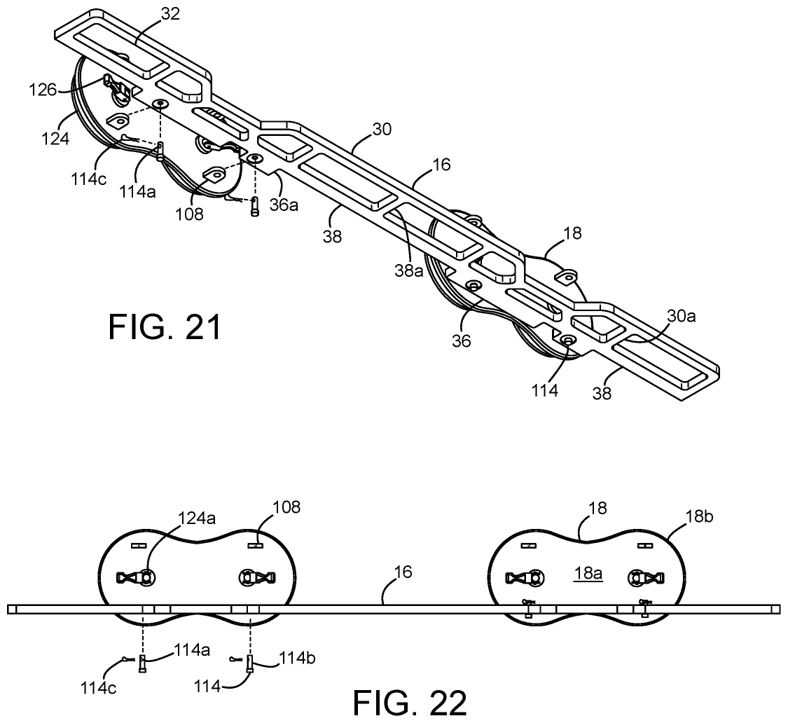

As further depicted in FIG. 20, fastening means and supplemental fastening means may individually incorporate locking capabilities to prevent outward slippage from its hold position, such as a spring-loaded pin 110 with a retractable ball 110a integrated within the structure of its shaft 110b, whereupon the retractable ball is capable of retracting inwardly into the shaft as a button 110c located at the head portion 110d is depressed and conversely, moves radially outward upon release of the button to fulfill a locking, stationary state of the shaft. Alternatively, fastening means and supplemental fastening means may individually comprise a bolt and nut arrangement 112, as in FIG. 4, or a headed pin 114 having an aperture 114a positioned about its shaft 114b to accept therewithin a cotter pin 114c or equivalent to prevent separation from its hold state, as in FIGS. 21 and 22.

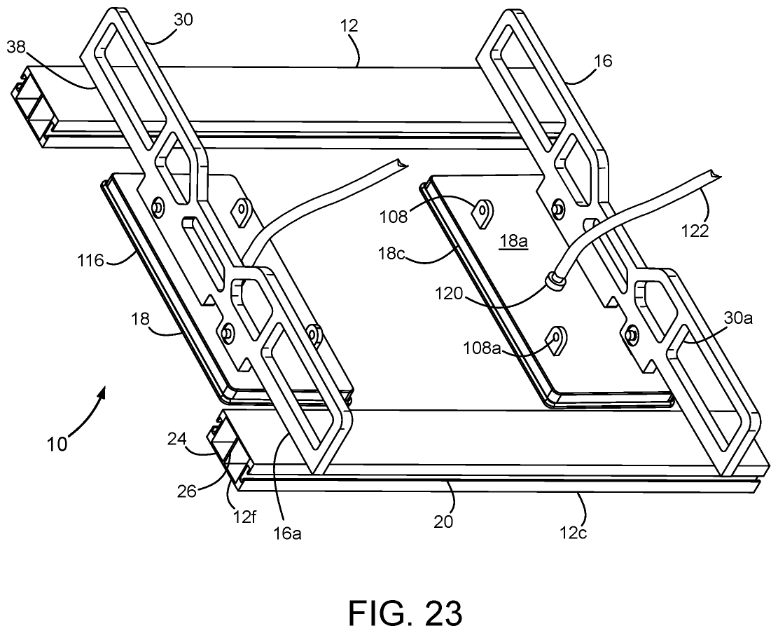

As understood within the context of this disclosure, a number of panel adherence devices 18 of the type available in the art and as shown in FIGS. 2, 4 and 22 are appropriately recognized to operate alongside the modular accessory 10 and characteristically possess common features, such as the top side 18a of the body plate 18b being configured with one or more upright posts 108 with the bottom side 18c being configured with structural provisions capable of fulfilling adherence to the planar surface 14a of the panel. Structural provisions in this regard may include a perimeter, deformable gasket 116 capable of forming an underside chamber 118 suited to hold a vacuum or negative pressure therewithin, whereupon a drawdown in pressure facilitated by an outside negative pressure source (not shown) yields slight deformation of the gasket to conform to and fulfill a tight bond to the planar surface 14a of the panel, as generally illustrated in FIG. 3. Other common aspects of the panel adherence device, as shown in FIGS. 4 and 23, may include a handle 54 mounted to the top side 18b and a hose adapter 120 mounted to the body plate 18b that offers communicative air passage through a hose 122 extending from the outside negative pressure source, such as a vacuum pump (not shown), to the underside chamber. In a more elaborate version compatible with the modular accessory 10, the panel adherence device of the type shown in FIG. 4 may be self-contained and configured with an internal air extraction component (not shown) to drawdown pressure from within the underside chamber 118 to sufficiently fulfill hold of the panel adherence device 18 to the planar surface of the panel, such as the model manufactured by Nemo Power Tools Limited of Hong Kong, China and sold under the registered trademark Grabo®.

In an alternative version suited to operate alongside the modular accessory 10, the panel adherence device of the type shown in FIGS. 21 and 22 may include one or more suctions cups 124 attached to and extending downwardly from the bottom side of the body plate with stems 124a upwardly passing through the body plate to accept and mount thereon a cam-acting lever 126. The cam-acting lever in this respect is capable of swivel motion and acts on the top side of the body plate while simultaneously pushing downwardly on the body plate 18a to forcibly compress the suction cups against the planar surface 14a of the panel to hold the desired position of the panel adherence device 18.

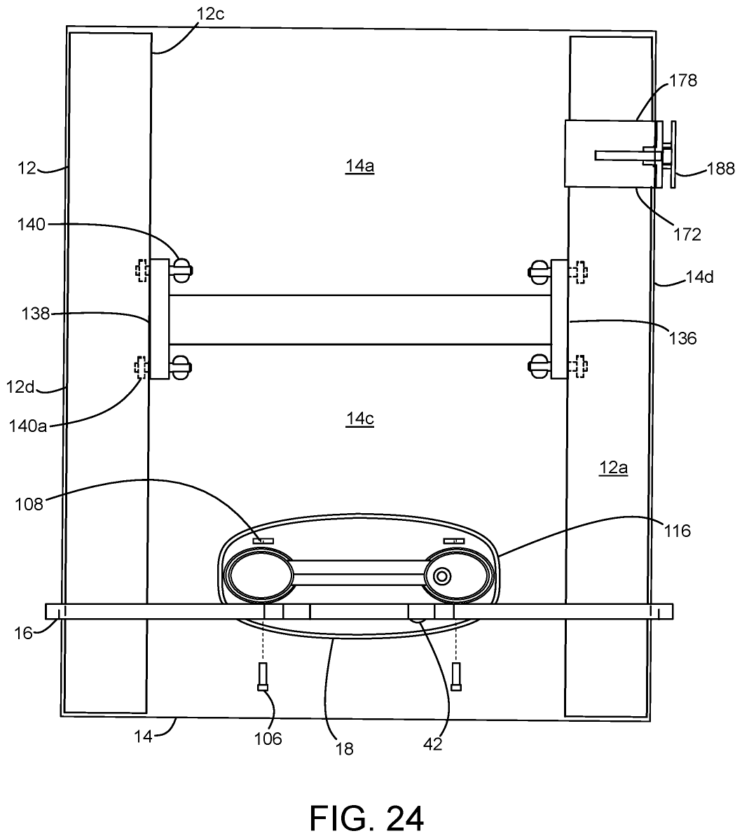

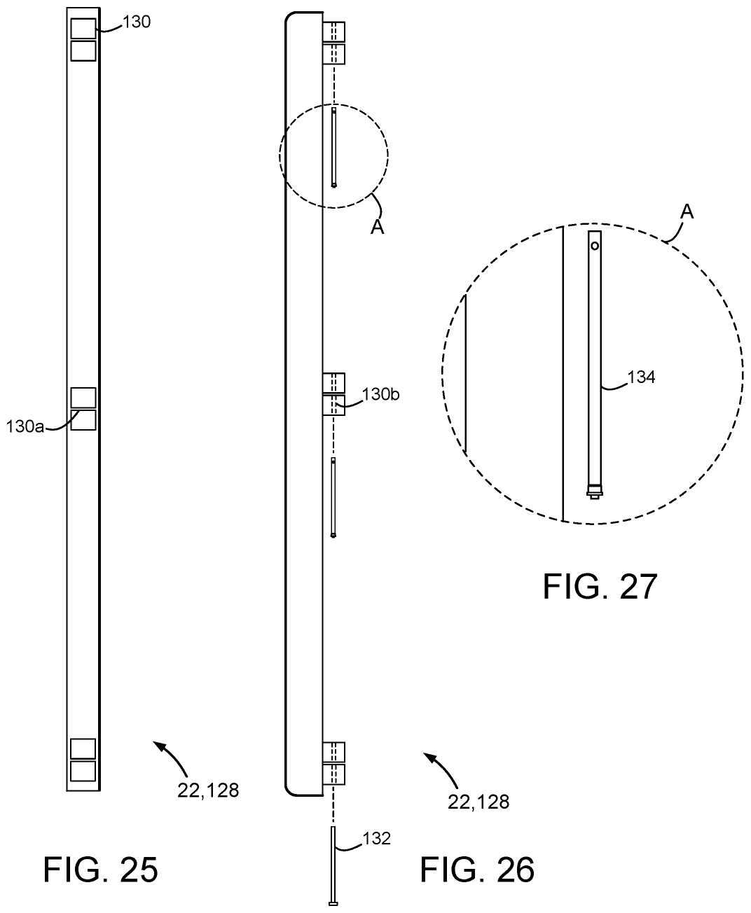

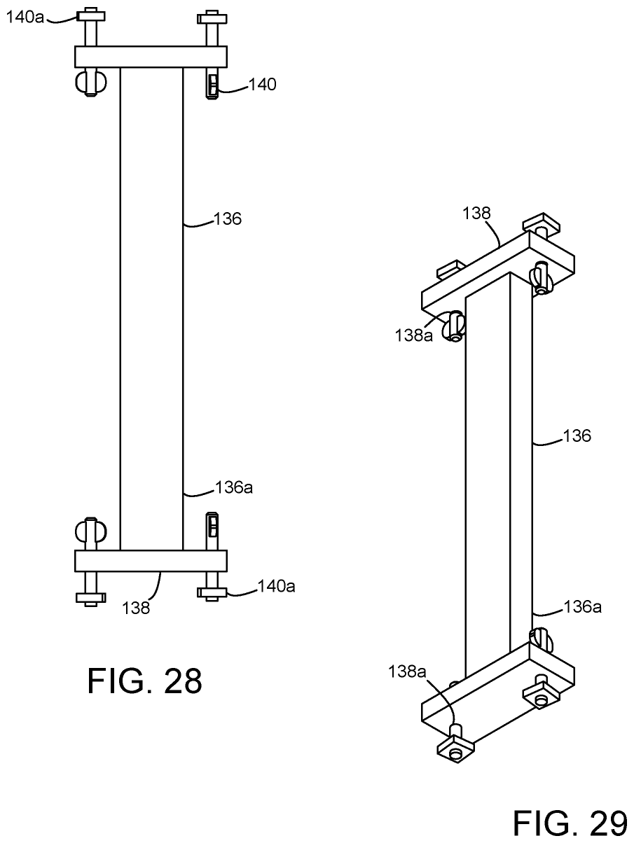

In FIGS. 1 and 24, the modular accessory 10 may be supplemented with a number of peripheral devices 22 that cumulatively enhance operability as well as being capable of operating independently to yield useful results particular to certain tasks. In one such exemplary case, an end rail 128 of the type shown in FIG. 1 may be configured to connect with ends of multiple box rails to fulfill predetermined spacing thereof that aptly forms a skeletal framework suited to directly coincide with the dimensional aspects of the panel, particularly as such to establish overall support of the panel that correlates to limiting the extent by which the panel may experience unwanted bending and twisting or possible breakage. In this regard, the end rail is shown in FIGS. 25 and 26 as being featured with adaptive blocks 130 mounted to one side thereof and coinciding in number to the number of box rails desirably used in the panel hold application, whereby each of the adaptive blocks includes a slot 130a to spatially accommodate the center divider 26 of the box rail 12 as the adaptive block is slidably inserted within the longitudinal openings 28 of the box rail. An elongate pin 132 of the type illustrated in FIG. 26 or as in FIG. 27, a spring-loaded pin 134 of the type generally used for hold of the bridge rail may be selectively placed within an aligned arrangement of apertures 12e, 130b respectively extending through the box rail and adaptive block to further securement of the end rail 128 relatively to the box rail's end. Similarly, as shown in FIGS. 28 and 29, a spacing bar 136 having ends 136a each configured with a planar element 138 that aptly abuts against the longitudinal sidewall of the box rail offers means for setting predetermined spacing of multiple box rails 12 relatively about the panel 14 for establishing a unified supportive, rigid structure. Securement of the spacing bar in this regard may be fulfilled by one or more bolts 140 extending through apertures 138a of the planar element and affixed thereat by a square nut 140a that suitably fits within the T-slot 20.

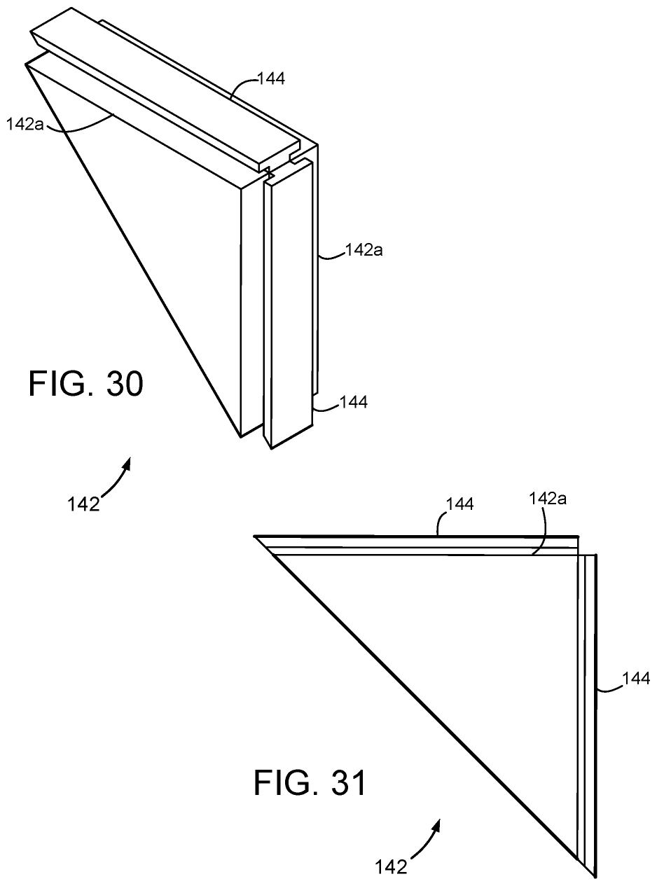

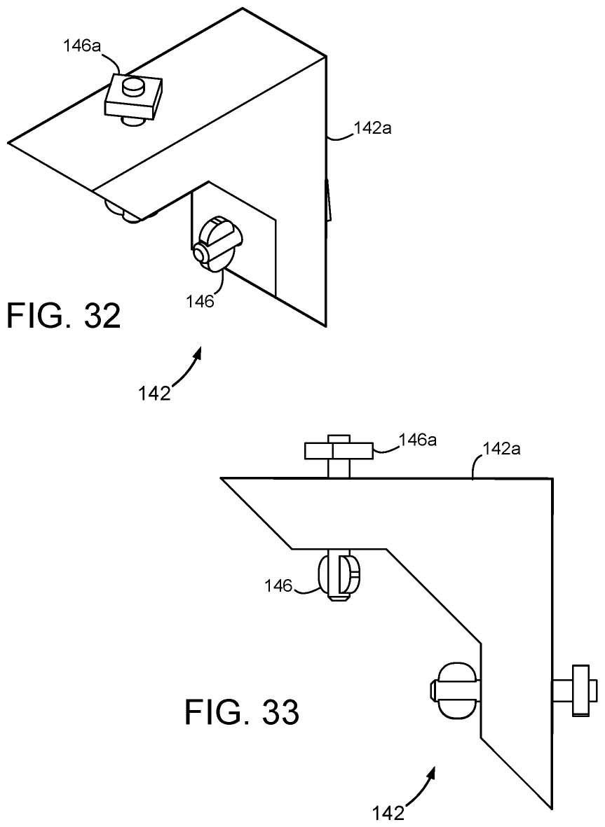

In furthering this supportive arrangement, the modular accessory 10 may employ use of a corner support 142 at junctions of a pair of box rails 12 perpendicularly orientated to one another, whereby the corner support includes a profiled extension 144 present about each of its two sides 142a that substantially resembles and conforms to the geometric configuration of the T-slot, as typically shown in FIGS. 30 and 31. Sliding the outward extensions of the corner support within the T-slots 20 of the box rails yields a perpendicular relation thereof. In lieu of the profiled extension, the corner support may alternatively attach to the box rail by way of an arrangement of a bolt 146 threadably connecting to a square nut 146a that proportionally fits within the T-slot, with each arrangement being designated for each of the two sides of the corner support, as depicted in FIGS. 32 and 33. Positioning the corner support at the desirable junction and tightening the square nut to the bolt yields a secure, perpendicular relation of the box rails, as generally shown in FIG. 1.

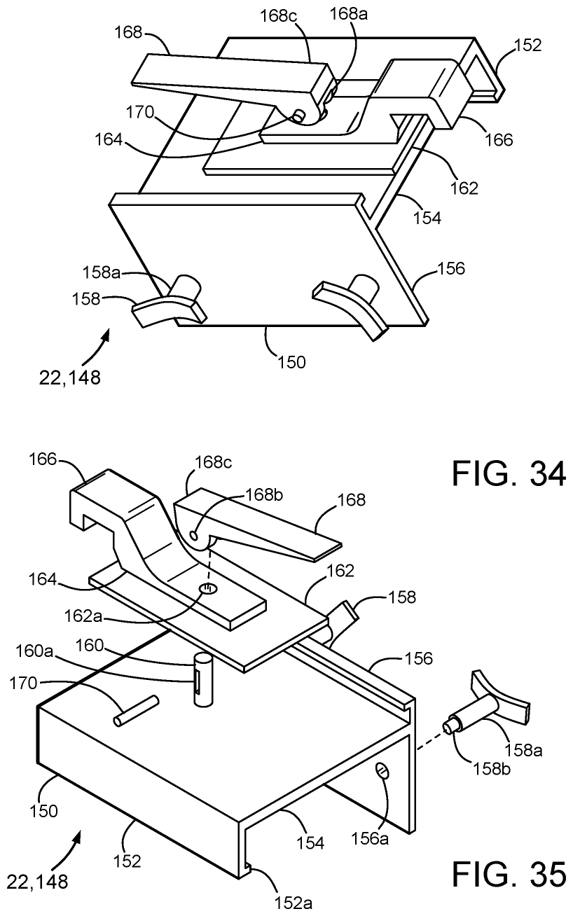

As illustrated in FIGS. 34 and 35, the modular accessory 10 may incorporate within its overall assembly a supplemental peripheral device in the form of a bridge rail clamp 148 that advances a secure connection of the bridge rail to the box rail 12 while connectively operating with the panel adherence device 18 to advance overall rigidity of the panel 14 during handling and transport operations. In this regard, a rail adapter 150 is shown in FIG. 20 as being positioned and attached to the box rail, where in particular a first sideward member 152 configured with an inward lip 152a extends downwardly from a top plate 154 to lockingly engage with a wall portion 20a of the T-slot integrated within the first longitudinal sidewall 12c of the box rail. Comparatively, a second sideward member 156 integrally connecting to and extending downwardly from the top plate, generally in an opposed and parallel relation to the first sideward member 152, engages the opposing, second longitudinal sidewall 12d of the box rail. One or more spring-loaded pins 158 each having a cylindrical barrel 158a mounted to the second sideward member and a retractable pin 158b capable of passing through and fitting within an aperture 156a extending through the second sideward member fulfills to engage an open portion 20b of the T-slot for temporary securement of the rail adapter to the box rail. In FIG. 35, the rail adapter 150 is further associated with a mount post 160 extending upwardly from and attached to the top plate 154 for fitment within an aperture 162a extending through a connective member 162. The connective member is shown in FIG. 35 to comprise a mount plate 164 integrally configured with a hook mechanism 166 capable of engaging a lower support 16a of the bridge rail. Supplementarily associated with bridge rail clamp 148, a cam lever 168 configured with an open slot 168a is depicted in FIG. 34 as adaptively engaging and fitting onto the mount post 160 after mountably accepting the connective member, whereby a set pin 170 fitting and passing into an aperture 168b extending through a cammed head portion 168c of the cam lever 168 and aligned with an elongate slot 160a of the mount post yields secure positioning of the cam lever. Accordingly, in assembled form, as the cam lever is depressed downwardly, by and through the camming action, the connective member 162 is downwardly urged against the top plate 154, while the hook mechanism 166 simultaneously grabs onto and engages the lower support of the bridge rail 16 to establish a tight hold of the box rail 12 relatively to the bridge rail.

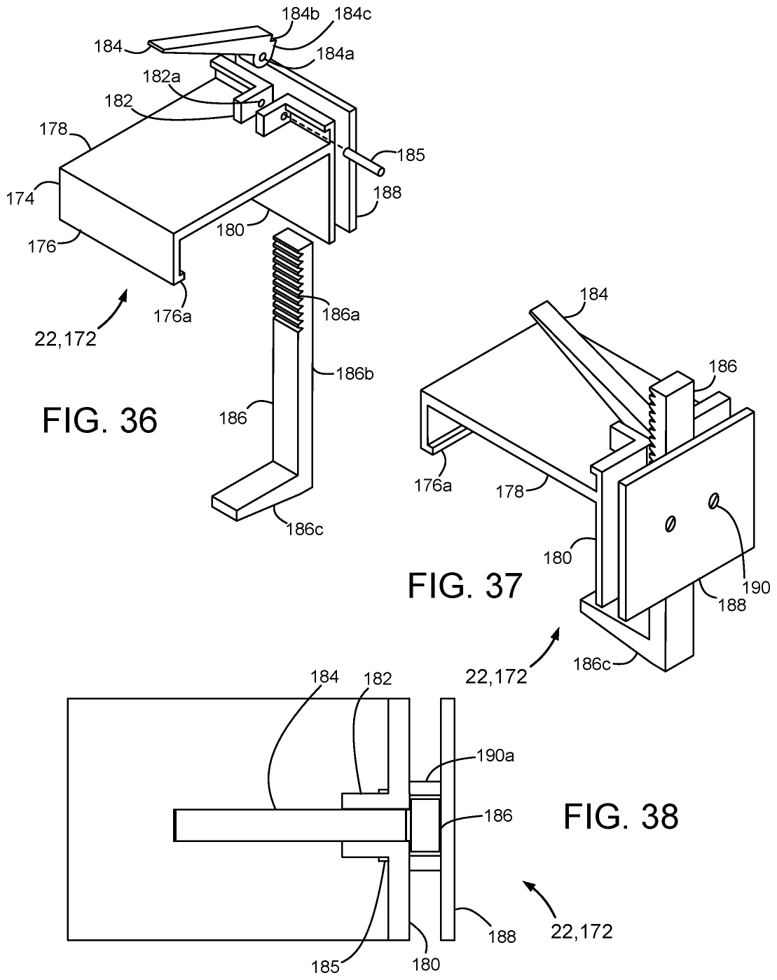

As an additional peripheral device 22, the modular accessory 10 may include within its overall assembly a box rail lock 172 that advances hold between the box rail and panel 14 during handling and transport operations. Similar to the construct of the rail adapter 150, the box rail lock is illustrated in FIGS. 36-38 as comprising a rail connector 174 with a first sideward element 176 configured with an inward rim 176a extending downwardly from an upper plate 178 to lockingly engage with the wall portion 20a of the T-slot 20 integrated within the first longitudinal sidewall 12c of the box rail, whereas a second sideward element 180 integrally connecting to and extending downwardly from the upper plate, generally in an opposed and parallel relation to the first sideward element, engages the second longitudinal sidewall 12d of the box rail. As further shown in FIGS. 36 and 38, the rail connector includes a pair of cam mount blocks 182 extending upwardly from the upper plate 178 in a parallel orientation to one another with each having an aperture 182a extending therethrough to align with an aperture 184a extending through a cam ratching lever 184 for accepting therein a cam pin 185 to hold placement of the cam ratching lever. The cam ratching lever, as specifically depicted in FIG. 36, comprises a notch 184b configured within the periphery of a cam head 184c, wherein the notch is capable of interactively meshing with a series of teeth 186a integrated within the structure of a drop-down support 186 such to advance upward and downward movement thereof. A backing plate 188 is shown in FIGS. 37 and 38 as being connected to the second sideward element 180 by screws 190, pins or equivalent fitted within an optional spacer 190a such to form a predetermined amount of space in between the backing plate and second sideward element to spatially accommodate an extendable portion 186b of the drop-down support. Individual screws fitted with or without the optional spacer, as depicted in FIG. 38, generally exist relatively about each side of the extendable portion to assist in maintaining its vertical orientation within the formed space such to allow the teeth of the drop-down support to properly align and interactively engage with the notch 184b. A lower support 186c associated with the drop-down support 186 and integrally connecting to and extending outwardly from the extendable portion offers to engage with an underside surface 14b of the panel, whereupon continued, downward ratching of the cam ratching lever 184 causes the lower support to move upwardly to the extent a top side 14c of the panel engages and fulfills firm hold with the bottom planar surface 12b of the box rail.

Now by way of briefly exemplifying description of the assembly and functionally of the modular accessory 10, one may appreciably gain further insight into the relatedness and interaction of the operative components discussed thus far that principally fulfill the utilitarian objects of the invention.

In typical installations, as generally directed to handling and transporting a panel of rectangular configuration, the box rails 12 are preferably positioned lengthwise alongside each of the panel's longitudinal sides 14d, with one or more panel adherence devices 18 being preferably situated midway in between the box rails to provide for even distribution and support relatively about the panel. Optionally, the box rails may be configured together as a combined unit by way of the end rail 128 fitting into and attaching to accessible ends 12f of the box rails, as shown in FIG. 1, or alternatively, as in FIG. 24, through use of the spacing bar 136 with each of its ends 136a abutting the longitudinal sidewalls of the box rail and connecting to its associated T-slot 20 integral thereto by the bolt 140 and square nut 140a arrangement.

After fulfilling the proposed layout of the assembly, one or more bridge rails 16, each of appropriate length that enables reach to the box rails 12, is positioned alongside the panel adherence device, with each of the open sockets of the bridge rail being slidably fitted onto the upright posts 108 present about one side of the panel adherence device. Fastening means in the form of a spring-loaded pin 110, for example, is slidably positioned within the aligned arrangement of apertures extending through the support walls 46 of the open sockets 44 and upright posts for temporary securement of the bridge rail. As the panel adherence device is operably activated to advance attachment to the planar surface 14a of the panel, a corresponding force is applied downwardly along the recessed portions of the bridge rail onto the top planar surfaces 12a of the box rails to yield overall support and rigidity to the panel.

It is contemplated within the scope of the modular accessory that numerous arrangements thereof may be employed or needed to fulfill rigid support of panels of varying geometric shapes and sizes, such as in the case of countertop construction configured as an L-shape, for example. Accordingly, it may be desired to arrange a first pair of box rails 12 along longitudinal sides 14d of one panel 14 with a second pair of box rails positioned on a second panel that abuts the first pair of box rails in a perpendicular manner and connects thereto using corner supports 142. Once arranged, an appropriate number of bridge rails generally connecting to an equal number of panel adherence devices and operably activated of their adhering functionality offers unified support about the entire panel that correspondingly extends overall rigidity thereof to fulfill safe handling and transport operations. In other related cases, it is conceivable that the second panel may comprise a width that is not necessarily conducive to spatially accommodating multiple box rails to the extent noted previously. In this regard, a single box rail 12, in an abutting and connecting arrangement with one of the box rails from the first pair of box rails, may be used and positioned in proximity to one of the longitudinal sides 14d of the second panel, while a span rail connecting to the panel adherence device 18 in a crosswise manner and engaging the box rail functionally extends unified support to the second panel with that of the first panel, typically in the manner shown in FIG. 1.

In supplementing each of the assemblies, as exemplarily described above, the modular accessory 10 may incorporate use of a bridge rail clamp 148 and/or a box rail lock 172 to respectively unify connectivity of the bridge rail to the box rail and box rail to the panel. In usage of the bridge rail clamp, for example, the rail adapter 150 thereof is positioned about the box rail with the first and sideward members 152, 156 respectively engaging the first and second longitudinal sidewalls 12c, 12d of the box rail 12 while retractable pins 158b of the spring-loaded pins 158 are selectively operated to fit within the open portion 20b of the T-slot integral to the box rail for securement of the bridge rail clamp, as generally represented in FIG. 20. The hook mechanism 166 of the connective member 162 is selectively positioned to align with and engage the lower support of the bridge rail, whereby downward applied force upon the associated cam lever 168 correspondingly allows the connective member to press against the top plate with the hook mechanism tightly engaging hold on the bridge rail 16 to advance unified connectivity thereof with that of the box rail. Comparatively, the rail connector 174 of the box rail lock 172 is positioned relatively about the box rail, with the lower support 186c of the drop-down support 186 being positioned to engage with the underside surface 14b of the panel, particularly in the manner shown in FIG. 1. Downward ratching of the associated cam ratching lever 184 consequentially advances the lower support to move upwardly to the extent that the top side 14c of the panel engagingly contacts and fulfills firm hold with the bottom planar surface 12b of the box rail.

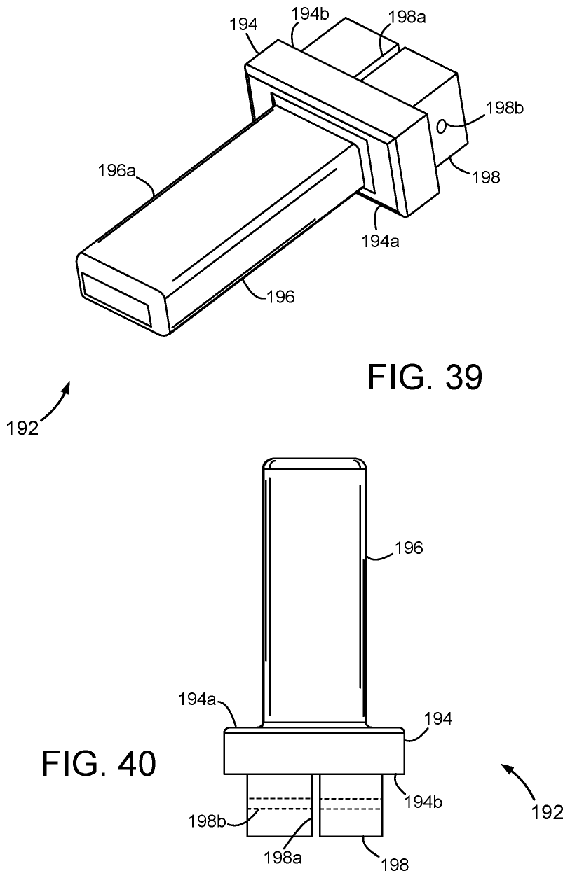

In certain applications that particularly involve handling of overly-sized panels and/or heavily-weighted panels, the modular accessory 10 may incorporate within its overall assembly one or more moveable handles 192, generally in addition to those that may be available and exist within the structure of the bridge rail 16 and panel adherence devices 18. As shown in FIGS. 39 and 40, each moveable handle includes an integral base plate 194, an outward member 196 constituting a handle portion 196a extending outwardly from a first side 194a of the integral base plate, and an adapter mount 198 extending outwardly from a second side 194b of the integral base plate, whereby the adapter mount comprises a structure substantially resembling the adapter block associated with the end rail. In this regard, the adapter mount includes an integral slot 198a for accommodating the center divider 26 of the box rail as the adapter mount is inserted within the accessible end 12f of the box rail. Secure placement of the moveable handle at the accessible end of the box rail is accomplished by a lengthened headed pin, bolt or a spring-loaded pin 200 to the likes associated with fastening means, wherein the pin or bolt is slidably positioned within the aligned arrangement of an aperture 198b extending through the adapter mount 198 and the aperture 12e extending through the box rail, in proximity to its accessible end 12f, as generally shown in FIG. 1.

It is obvious that the components comprising the modular accessory 10 may be fabricated from a variety of materials, providing such selection or use of materials possess the capacity to withstand forces acting thereon throughout its duration of use as well as limiting occurrences of premature failure due to repeated forces acting thereon during panel-supporting operations. Accordingly, it is most desirable, and therefore preferred, to construct the modular accessory 10, namely, the box rails 12, bridge rails 16, end rails 128, and rail connector 174 and rail adapter 150 respectively associated with the box rail lock 172 and bridge rail clamp 148 from extruded aluminum or an equivalent type of material that meaningfully offers reasonable structural strength for its weight, while limiting the extent by which the components may unacceptably fail due to applied stresses.

While there has been shown and described a particular embodiment of the invention, it will be obvious to those skilled in the art that various changes and alterations can be made therein without departing from the invention and, therefore, it is aimed in the appended claims to cover all such changes and alterations which fall within the true spirit and scope of the invention.

What is claimed is:

1. A modular accessory for use with panel adherence devices each having upright posts, said modular accessory comprising, in combination:
one or more box rails each having a top planar surface, a first longitudinal sidewall, and a second longitudinal sidewall;
at least one bridge rail having one or more extended sections extending downwardly from a bottom side of the bridge rail to form a recessed portion on each side of said extended section to engage said top planar surface of the box rail;
one or more open sockets formed within said extended section and each being capable of slidably fitting onto the upright post of the panel adherence device; and
fastening means for securing said open socket to the upright post of the panel adherence device.

2. The modular accessory as set forth in claim 1, wherein said open socket includes a pair of support walls each configured with an aperture for accepting said fastening means, said fastening means having a spring-loaded pin configured with a shaft for passing through said aperture and a retractable ball for fulfilling hold of said spring-loaded pin while within said aperture.

3. The modular accessory as set forth in claim 1, wherein said extended section of the bridge rail is bounded by a pair of outward walls each of dimensional length set by the difference in heights between said top planar surface of the box rail and a top side of the panel adherence device.

4. The modular accessory as set forth in claim 1, wherein said bridge rail comprises a perimeter frame with a lower support and integral handles formed by said perimeter frame integrally connecting to internal supports.

5. The modular accessory as set forth in claim 1, wherein said extended section of the bridge rail includes one or more cutouts for spatially accommodating operative components associated with the panel adherence device.

6. The modular accessory as set forth in claim 1, further comprising a moveable handle having an adapter mount and an outward member, each of said box rails having a pair of longitudinal openings and an accessible end for respectively accommodating therewithin and mounting thereto said adapter mount.

7. The modular accessory as set forth in claim 6, further comprising an end rail having at least two adaptive blocks each mounting to said accessible end of the box rail and fitting within said longitudinal openings of the box rail, wherein the number of said adaptive blocks equates to the number of said box rails.

8. The modular accessory as set forth in claim 1, further comprising a spacing bar having ends each being configured with a planar element, said planar element having at least one aperture extending therethrough for accommodating a fastener suited to connectively interact with a T-slot of said first or second longitudinal sidewall.

9. The modular accessory as set forth in claim 4, further comprising a bridge rail clamp having a rail adapter configured with a top plate integrally connecting to a first sideward member with an inward lip capable of fitting within a T-slot of said first longitudinal sidewall and a second sideward member capable of attaching to second said longitudinal sidewall, a connective member positioned atop of said rail adapter and having a mount plate integrally configured with a hook mechanism capable of engaging said lower support of the bridge rail, a mount post connecting to said top plate and extending upwardly therefrom and passing through said mount plate, and a cam lever adaptively attached to said mount post, whereby downward depression of said cam lever, by and through the camming action thereof, urges downwardly said connective member against said rail adapter to advance hold of said box rail with that of said bridge rail.

10. The modular accessory as set forth in claim 9, further comprising one or more spring-loaded pins each having a cylindrical barrel fixedly attached to said second sideward member configured with an aperture and a retractable pin slidably positioned within said cylindrical barrel and passing through said aperture for connectively engaging a T-slot of said second longitudinal sidewall.

11. The modular accessory as set forth in claim 1, further comprising a span rail having an open framed member formed by a top member integrally connecting to a pair of sides, each of said sides having a pair of dual extending flanges individually capable of slidably fitting onto the upright post of the panel adherence device and having an aperture extending therethrough for accommodating supplemental fastening means.

12. The modular accessory as set forth in claim 11, wherein each of said sides of the span rail comprises an outward arm extending outwardly therefrom to interactively engage with said top planar surface of the box rail.

13. The modular accessory as set forth in claim 11, wherein each of said sides of the span rail comprises an outward arm extending outwardly therefrom to interactively engage with said top planar surface of the box rail, said span rail having a pair of extended members each extending outwardly beyond said side of the span rail and positioned relatively above each of said outward arms.

14. The modular accessory as set forth in claim 11, wherein each of said sides of the span rail comprises an outward arm extending outwardly therefrom to interactively engage with said top planar surface of the box rail, said span rail having an integral handle formed by a vertical member integrally connecting to one of said outward arms and an extended member extending outwardly beyond one of said sides of the span rail.

15. The modular accessory as set forth in claim 11, wherein one of said sides of the span rail comprises an outward arm extending outwardly therefrom to interactively engage with said top planar surface of the box rail.

16. The modular accessory as set forth in claim 11, wherein one of said sides of the span rail comprises an outward arm extending outwardly therefrom to interactively engage with said top planar surface of the box rail, said span rail having an extended member extending outwardly beyond said side of the span rail and positioned relatively above said outward arm.

17. The modular accessory as set forth in claim 11, wherein one of said sides comprises an outward arm extending outwardly therefrom to interactively engage with said top planar surface of the box rail, said span rail having an extended member extending outwardly beyond said side and positioned relatively above said outward arm and an upper handle formed by a horizontal member integrally connecting to a pair of extended side members with each thereof integrally connecting to said side of the span rail.

18. The modular accessory as set forth in claim 1, further comprising a box rail lock having a rail connector configured with an upper plate integrally connecting to a first sideward element with an inward rim capable of fitting within a T-slot of said first longitudinal sidewall and a second sideward element capable of engaging said second longitudinal sidewall, a pair of cam mount blocks each connecting to and extending upwardly from said upper plate, a cam ratching lever being positioned in between and connecting to said cam mount blocks and having a cam head with a notch, a drop-down support having a lower support and a series of teeth for interactively meshing with said notch, and a backing plate connecting to said second sideward element to form a predetermined amount of space in between said backing plate and said second sideward element to spatially accommodate an extendable portion of said drop-down support, whereby downward depression of said cam ratching lever, by and through the camming action thereof, urges upwardly said lower support against an underside surface of the panel to advance hold of said box rail with that of the panel.

19. The modular accessory as set forth in claim 1, further comprising a corner support for securing together and maintaining orientation of said box rails numerically as a pair and having a pair of sides each with a profiled extension geometrically corresponding to a T-slot of said first or second longitudinal side to fulfill its capability to slidably fit within said T-slot.

20. The modular accessory as set forth in claim 1, further comprising a corner support for securing together and maintaining orientation of said box rails numerically as a pair and having a pair of sides each configured with a bolt and nut assembly capable of connectively interacting with a T-slot of said first or second longitudinal side.

21. A modular accessory for use with panel adherence devices each having upright posts, said modular accessory comprising, in combination:
one or more box rails each having a top planar surface, a first longitudinal sidewall, and a second longitudinal sidewall;
one or more span rails each having an open framed member formed by a top member integrally connecting to a pair of sides, each of said sides having a pair of dual extending flanges individually capable of slidably fitting onto the upright post of the panel adherence device; and
supplemental fastening means for securing said dual extending flanges to the upright post of the panel adherence device.

22. The modular accessory as set forth in claim 21, wherein each of said sides of the span rail comprises an outward arm extending outwardly therefrom to interactively engage with said top planar surface of the box rail.

23. The modular accessory as set forth in claim 21, wherein each of said sides of the span rail comprises an outward arm extending outwardly therefrom to interactively engage with said top planar surface of the box rail, said span rail having a pair of extended members each extending outwardly beyond said side of the span rail and positioned relatively above each of said outward arms.

24. The modular accessory as set forth in claim 21, wherein each of said sides of the span rail comprises an outward arm extending outwardly therefrom to interactively engage with said top planar surface of the box rail, said span rail having an integral handle formed by a vertical member integrally connecting to one of said outward arms and an extended member extending outwardly beyond one of said sides of the span rail.

25. The modular accessory as set forth in claim 21, wherein one of said sides of the span rail comprises an outward arm extending outwardly therefrom to interactively engage with said top planar surface of the box rail.

26. The modular accessory as set forth in claim 21, wherein one of said sides of the span rail comprises an outward arm extending outwardly therefrom to interactively engage with said top planar surface of the box rail, said span rail having an extended member extending outwardly beyond said side of the span rail and positioned relatively above said outward aim.

27. The modular accessory as set forth in claim 21, wherein one of said sides comprises an outward arm extending outwardly therefrom to interactively engage with said top planar surface of the box rail, said span rail having an extended member extending outwardly beyond said side and positioned relatively above said outward arm and an upper handle formed by a horizontal member integrally connecting to a pair of extended side members with each thereof integrally connecting to said side of the span rail.

28. The modular accessory as set forth in claim 21, further comprising a spacing bar having ends each being configured with a planar element, said planar element having at least one aperture extending therethrough for accommodating a fastener suited to connectively interact with a T-slot of said first or second longitudinal sidewall.

29. The modular accessory as set forth in claim 21, further comprising a box rail lock having a rail connector configured with an upper plate integrally connecting to a first sideward element with an inward rim capable of fitting within a T-slot of said first longitudinal sidewall and a second sideward element capable of engaging said second longitudinal sidewall, a pair of cam mount blocks each connecting to and extending upwardly from said upper plate, a cam ratching lever being positioned in between and connecting to said cam mount blocks and having a cam head with a notch, a drop-down support having a lower support and a series of teeth for interactively meshing with said notch, and a backing plate connecting to said second sideward element to form a predetermined amount of space in between said backing plate and said second sideward element to spatially accommodate an extendable portion of said drop-down support, whereby downward depression of said cam ratching lever, by and through the camming action thereof, urges upwardly said lower support against an underside surface of the panel to advance hold of said box rail with that of the panel.

30. The modular accessory as set forth in claim 21, wherein each of said dual extending flanges comprises an aperture extending therethrough for accommodating said supplemental fastening means, said supplemental fastening means comprises a spring-loaded pin configured with a shaft for passing through said aperture and a retractable ball for fulfilling hold of said spring-loaded pin while within said aperture.

31. A modular accessory for use with panel adherence devices each having upright posts, said modular accessory comprising, in combination:
a plurality of box rails each having a top planar surface, a first longitudinal sidewall, and a second longitudinal sidewall extending parallel to said first longitudinal sidewall;
at least one bridge rail having one or more extended sections extending downwardly from a bottom side of the bridge rail to form a recessed portion on each side of said extended section to engage said top planar surface of the box rail, a pair of open sockets formed within said extended section and each being capable of slidably fitting onto the upright post of the panel adherence device, and a perimeter frame with a lower support;
one or more span rails each having an open framed member formed by a top member integrally connecting to a pair of sides, each of said sides having a pair of dual extending flanges individually capable of slidably fitting onto the upright post of the panel adherence device, said span rail having an outward arm extending outwardly from one of said sides to interactively engage with said top planar surface of the box rail;
fastening means for securing said open socket to the upright post of the panel adherence device; and
supplemental fastening means for securing said dual extending flanges to the upright post of the panel adherence device.

32. The modular accessory as set forth in claim 31, further comprising a box rail lock having a rail connector configured with an upper plate integrally connecting to a first sideward element with an inward rim capable of fitting within a T-slot of said first longitudinal sidewall and a second sideward element capable of engaging said second longitudinal sidewall, a pair of cam mount blocks each connecting to and extending upwardly from said upper plate, a cam ratching lever being positioned in between and connecting to said cam mount blocks and having a cam head with a notch, a drop-down support having a lower support and a series of teeth for interactively meshing with said notch, and a backing plate connecting to said second sideward element to form a predetermined amount of space in between said backing plate and said second sideward element to spatially accommodate an extendable portion of said drop-down support, whereby downward depression of said cam ratching lever, by and through the camming action thereof, urges upwardly said lower support against an underside surface of the panel to advance hold of said box rail with that of the panel.

33. The modular accessory as set forth in claim 31, further comprising a bridge rail clamp having a rail adapter configured with a top plate integrally connecting to a first sideward member with an inward lip capable of fitting within a T-slot of said first longitudinal sidewall and a second sideward member capable of attaching to said second longitudinal sidewall, a connective member positioned atop of said rail adapter and having a mount plate integrally configured with a hook mechanism capable of engaging said perimeter frame of the bridge rail, a mount post connecting to said top plate and extending upwardly therefrom and passing through said mount plate, one or more spring-loaded pins each having a cylindrical barrel fixedly attached to said second sideward member configured with an aperture and a retractable pin slidably positioned within said cylindrical barrel and passing through said aperture for connectively engaging a T-slot of said second longitudinal sidewall, and a cam lever adaptively attached to said mount post, whereby downward depression of said cam lever, by and through the camming action thereof, urges downwardly said connective member against said rail adapter to advance hold of said box rail with that of said bridge rail.
